(19) United States
(12) Patent Application Publication
(10) Pub. No.: US 2019/0303926 A1
(43) Pub. Date: Oct. 3, 2019

(54) BLOCKCHAIN LOAN TRANSACTION SYSTEMS AND METHODS

(71) Applicant: Exposition Park Holdings SEZC, Grand Cayman (KY)

(72) Inventors: Jonathan Yantis, Grant's Pass, OR (US); William Edward Quigley, Pacific Palisades, CA (US)

(21) Appl. No.: 16/370,283

(22) Filed: Mar. 29, 2019

Related U.S. Application Data
(60) Provisional application No. 62/650,827, filed on Mar. 30, 2018.

(51) Int. Cl. G06Q 20/38; G06Q 40/02

(52) U.S. Cl. CPC G06Q 20/389; G06Q 40/025

(57) ABSTRACT

A system and methods are described for utilizing smart contracts in a public blockchain to coordinate, document, and execute loan transactions. A contract deployed to the blockchain is accessible to borrowers to add a loan request to the public blockchain and to lenders who will evaluate the loan request and offer a loan. A loan agreement and repayment may also be deployed to the blockchain. A third party transfer agent may use the public blockchain to transfer non-digital or programmatically inaccessible assets as part of the loan agreement.

### CROSS-REFERENCE TO RELATED APPLICATIONS

This application claims the benefit of U.S. Provisional Application 62/650,827, filed Mar. 30, 2018, all of which is incorporated by reference in its entirety.

### BACKGROUND

### 1. Field of the Invention

The systems and methods described herein are in the field of blockchain technologies and smart contracts, specifically in the field of utilizing smart contracts and blockchains to document and implement loan transactions.

### 2. Description of the Related Art

The combination of blockchain technology and smart contracts has been proposed for use in systems and methods for implementing a variety of transactions in a way that automates much of the transaction while preserving and respecting the legal constraints on such automation. One of the limitations on automation of such systems is the existence of jurisdiction specific rules and processes for (i) creating legally binding contracts between parties, and (ii) exchanging property in a way that transfers ownership interests, security interests, or other similar interests in a legally binding manner.

Some of the proposed systems depend on the future implementation of blockchain technology for the legal systems of record for such transfers, including real property records, Uniform Commercial Code filing systems, and other similar systems. This transition is dependent on governmental bodies creating and adopting blockchain-based record-keeping systems. For example, real property records in the United States are typically maintained at the county-level by an elected official, and documents are subject to specific rules regarding format and methods of submission to the record. Each such official utilizes their own systems to accept and record documents. Adoption of a blockchain-based record-keeping system would thus require each jurisdiction to select and implement such a system. This process can take years even once the technology for such systems is developed and available for implementation. The willingness of jurisdictions to adopt new technologies also may vary widely, and so it is impossible to determine when all jurisdictions will migrate to a blockchain-based system, if ever.

Since the benefits of blockchain technologies should not wait until governmental record keepers decide to begin to implement systems based on the technology, hybrid systems that provide the benefits of blockchain technology but also interface with existing record-keeping and other legal systems are necessary to bridge the gap. Systems like those disclosed herein provide the benefits of blockchain to users of the system, interface with existing legal systems and methods, and will be easier to migrate to a full block-chain based system if they become available.

### SUMMARY OF THE INVENTION

In various embodiments, the invention comprises a system for implementing, documenting, and executing loan transactions utilizing smart contracts on blockchain technology, and a transfer agent for addressing funds transfer and collateral requirements that cannot be met by smart contracts.

In an embodiment, a method performed by a computing system includes deploying into a blockchain computer-executable program contract code of a loan contract specifying an asset to be transferred between a lender and a borrower, wherein said computer-executable program code further comprises one or more invokable methods; under control of the contract code, deploying into the blockchain a loan request; under control of the contract code, accessing the loan request and offering a loan; and under control of the contract code, deploying into the blockchain a loan agreement specifying the terms of a loan between the lender and the borrower.

In a further embodiment, the asset is digital and the loan transaction is executed under control of the contract code.

In another embodiment, the asset is tangible, and the method also includes selecting a transfer agent; executing the loan agreement; and deploying into the blockchain loan repayment data.

In yet another embodiment, the one or more invokable methods include a loan request method, a loan review method, a loan modify method and a loan accept method.

In an embodiment, a loan request method further includes accepting at least one proposed loan term from the borrower; and deploying into the blockchain the at least one proposed loan term as a loan request. In another embodiment, a loan review method includes reviewing a loan request; and deploying into the blockchain an acceptance of the loan request. In another embodiment, the loan modify method includes under control of the contract code, deploying into the blockchain a counter offer. In yet another embodiment, the loan accept method includes deploying into the blockchain an agreement on the final terms of the loan contract.

In an embodiment, a computing system for executing a loan transaction includes a processor for executing computer-executable instructions; and a computer-readable storage medium containing computer-executable instructions that when executed by the processor control the computing system to deploy into a blockchain computer-executable program contract code of a loan contract specifying an asset to be transferred between a lender and a borrower; deploy into the blockchain a loan request; and deploy into the blockchain a loan agreement specifying the terms of a loan.

In a further embodiment the asset is digital and the loan transaction is executed under control of the contract code. In another embodiment, the asset is tangible and the computer-readable storage medium containing computer-executable instructions that when executed by the processor control the computing system to select a transfer agent; execute the loan agreement; and deploy into the blockchain loan repayment data.

In another embodiment, the one or more invokable methods further comprise a loan request method, a loan review method, a loan modify method and a loan accept method.

In an embodiment, a method performed by a computing system for executing a loan transaction includes deploying into a public blockchain computer-executable program contract code of a loan contract specifying an asset to be transferred between a lender and a borrower, wherein said computer-executable program code further comprises one or more invokable methods; under control of the contract code, providing access to an invokable loan request method for requesting a loan to a borrower; under control of the loan request method, deploying into the public blockchain a loan request further comprising at least one term of the loan; under control of the contract code, providing access to an invokable loan review method for accessing the loan request to one or more lenders; and under control of the contract code, providing access to an invokable loan accept method for accepting the loan request to one or more lenders and deploying a loan agreement to the public blockchain.

In a further embodiment, the loan request includes contact information for the borrower and a lender contacts the borrower directly.

In a further embodiment, the asset is digital and the loan transaction is executed under control of the contract code. In yet another embodiment, the asset is tangible and the method includes selecting a transfer agent to execute the loan agreement and deploy into the public blockchain loan repayment data.

In an embodiment, the loan agreement includes collateral for the loan. In a further embodiment, the collateral includes a virtual gaming asset.

In yet another embodiment, the one or more invokable methods further include a loan modify method and the loan modify method further includes under control of the contract code, deploying into the blockchain a counter offer.

### BRIEF DESCRIPTION OF THE DRAWINGS

FIG. 1 is a schematic view of an embodiment of the systems and methods of the blockchain loan system described herein.

FIG. 2 is a schematic view of an embodiment of the systems and methods of the blockchain loan system described herein.

FIG. 3 is a block diagram of a computer or system hardware architecture for implementing the system of FIG. 1.

### DETAILED DESCRIPTION

The blockchain transaction systems and methods described herein utilize blockchain technology in combination with smart contracts to allow users to negotiate, document, and execute a variety of different transactions, such as loan transactions. These loan transactions include loan transactions that are secured by traditional types of collateral as well as by digital assets.

Blockchain technology forms the basis for cryptocurrencies that are rapidly expanding in application and adoption. Such cryptocurrencies augment or replace existing payment methodologies such as cash, but also provide a decentralized system for processing transfers of the cryptocurrency. The basis for the blockchain technology is a linked list of data blocks. Each block contains a link to the prior block in the chain and encrypted data. In some implementations of a blockchain, the encrypted data may include transaction data documenting the exchange of a digital currency, software such as an executable digital contract, and data associated with the use of a digital contract by specific parties, although it may also include other types of data as described in further detail below. The data in each block in the blockchain includes a hash of the previous block in the chain as a means of identifying and preventing attempts to modify prior blocks in the blockchain.

In many implementations of blockchain technology, the management and extension of the blockchain is decentralized and distributed over computer systems operated by numerous unaffiliated entities who contribute their computing power to the system. These distributed contributors provide the infrastructure of the blockchain system by storing copies of the blockchain, and performing the algorithms necessary to process transactions, deploy them into new blocks on the blockchain, and distribute those blocks to other parts of the system. In some blockchain implementations the contributors are compensated for this service by receiving a fee denominated in a cryptocurrency in return for the processing of a new block in the blockchain. An important aspect of blockchain security is that it is difficult to modify blocks after they have been added to the blockchain and accepted into the main branch, although blockchains do have temporary competing branches.

The blockchain technology has been enhanced by the concept of “smart contracts”. Smart contracts are executable computer programs that are compiled into the data in a block in the blockchain by the developers of the smart contract. Once the smart contract has been deployed into the blockchain other users of the blockchain may execute the smart contract with confidence that it has not been modified by a malicious third party. These executable computer programs are referred to as “smart contracts” because they may be used to represent and implement agreements between various parties regarding the transfer of digital currency and other types of assets, however, they do not have to represent contractual arrangements. A software developer develops the smart contract by writing program code using a scripting language such as JavaScript, Solidity, or other scripting languages, or an object coding language, such as Java, or a machine coding language such as C or C++. When a “smart contract” is deployed into the blockchain, the program code is processed into a block by one of the contributors to the system just as any other transaction on the blockchain, and typically a fee is paid to the node contributor who compiles the contract/program. The process of deploying the smart contract may include compiling the program code into bytecode, object code, binary code, or some other executable form. When the smart contract is successfully deployed into the block chain it is assigned an address just as any other blockchain transaction. This address is used to access the smart contract and execute the functionality provided in it. Typically, an Application Binary Interface (ABI) information, similar to an application programming interface, is provided to a user of the contract, or the software that interfaces with the contract (such as a wallet application) so that the user can interact with the various functions of the smart contract. The ABI describes the various functions and methods provided as part of the smart contract so that they can be accessed by the user or the user's software.

A contract/program that has been deployed into the blockchain may then be used by anyone who has the address of the contract on the blockchain. Executing the contract, or a portion of it, does not necessarily incur fees unless updates to the blockchain are required as part of that step in the contract. If the contract/program is properly implemented many different users may utilize the contract/program simultaneously to govern their own specific agreements or transactions.

The smart contract/program may have multiple steps that are executed or completed by different parties to the contract. For example, a contract/program may be invoked by a first party to make an offer to a second party or a group of potential contracting parties by instantiating a copy of a certain contract. The second party (or one of the group) may respond by “signing” that instance of the contract. The process of “signing” the contract may comprise invoking a programmatic method defined as part of the contract. Some contracts may provide for multiple parties, such as buyer, seller, lender, borrower, escrow agent, transfer agent, and others, all of whom may independently interact with a particular instance of a contract to sign it, or to take other actions associated with a specific type of contract.

Smart contracts are well suited to contracts that involve digital assets or that may be completely executed via programmatic interactions between the contracting parties, the blockchain, digital assets, and resources on the internet or otherwise connected digitally to the contract. For example, smart contracts may be able to automatically transfer control and ownership of digital assets or transfer money between PayPal or bank accounts via ACH or other electronic payment systems. Application programming interfaces provided by the external systems provide methods for a digital contract to execute actual transfers of assets or funds between parties without non-programmatic processes.

Smart contracts are not so readily able to fully implement agreements that involve tangible assets, such as real estate, personal property, and other types of assets that are subject to the control of governmental or private registration systems. These registration systems are often paper-based or, if electronic, are not designed for programmatic interaction by third parties. Examples of such systems include real estate ownership records, personal property records for assets that are titled, Uniform Commercial Code records, patent and trademark registration databases, and others. Many of these systems may be partially digital but are lacking in a programmatic interface for a smart contract to interact with the system in a completely automated manner or are highly proprietary in nature. Other systems may be fractured into many jurisdictions with their own separate filing systems, so that a single smart contract would not be functional across all relevant systems. For example, Uniform Commercial Code filings are typically handled by differing systems across different state jurisdictions, and a smart contract would need to implement varying interfaces to be able to handle transactions outside of a single jurisdiction, and depending on whether such interfaces were available for a given jurisdiction.

If such external governmental and private registration databases migrate onto a blockchain, or at least onto a system that is conducive to programmatic interface from third parties, then smart contracts may be able to natively and programmatically execute all such contracts in full. Until then smart contracts cannot be implemented for many important types of transactions without other systems and methods to allow the smart contract to interact with these other types of systems and resources. In such situations a transfer agent may be utilized to implement the non-programmatic processes required to complete a specific transaction, such as the transfer of physical property, the filing of necessary ownership transfer or security documents, and other such types of transactions.

One type of contract that is not able to be fully executed via the programmatic functions of a smart contract/program is a secured lending transaction. While many parts of such transactions may be completed via interactions between parties and the smart contract, the transfer of title and possession, and the creation of security interests for the benefit of lenders, among other aspects of the transaction, are not readily adapted to completion via the smart contract.

In the inventive system described herein, a blockchain is created to support one or more types of smart contracts. In various embodiments of the system, the blockchain might have a variety of types of smart contracts, such as loan contracts, employment contracts, lease contracts, etc. The programmatic smart contracts are compiled into that blockchain and reside at a certain address within a block in the blockchain. Users may utilize the contract by invoking the address and methods or functions associated with the smart contract. For example, a loan contract may have methods for a loan request, loan approval, collateral assignment, payment authorization, and other similar functions necessary to the formation and execution of a loan, the provision of collateral as security, and repayment of the loan according to its terms. For purposes of the examples described herein, the blockchain used by the system will be referred to as the Contract Blockchain, with the understanding that any blockchain that supports smart contracts could be utilized to support the system and serve the functions of the blockchain.

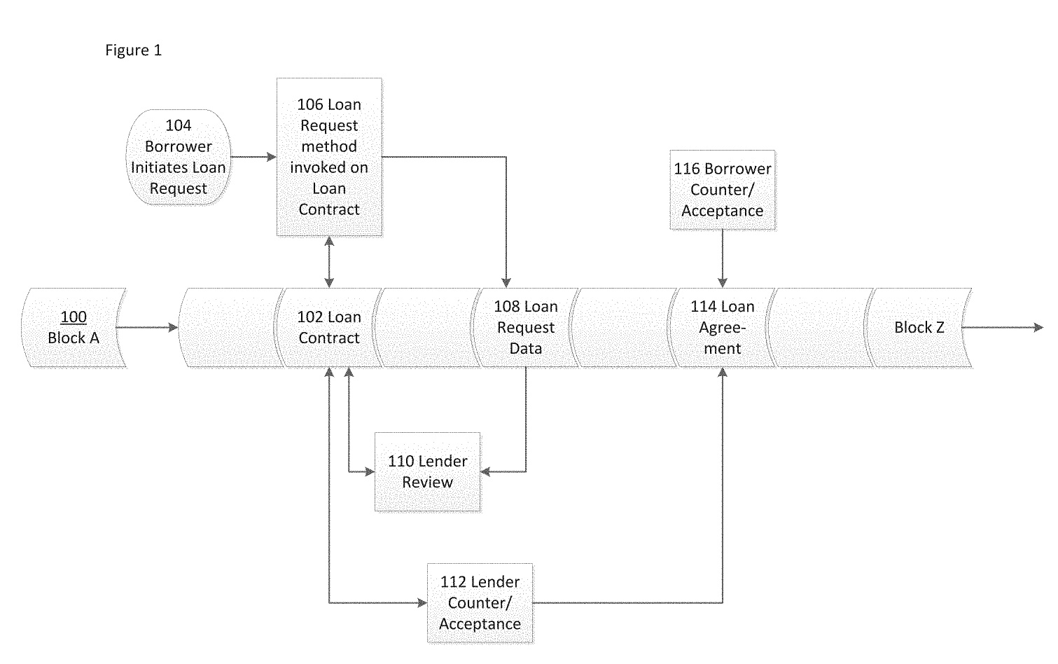

Continuing the loan contract example, when a user utilizes that smart contract and invokes a method or function of that contract, it may submit parameters and other information to the contract that are specified by a particular method or function. The contract will them programmatically execute a selected method or function in accordance with those parameters. In the case of a loan request function, the smart contract may take the parameters received from a user who desires to take out a loan, and incorporate that request information into a new block in the blockchain so that potential lenders can view the request. In some embodiments the loan request might not be incorporated into the blockchain, but might be stored in a database that is programmatically available to potential lenders such as via a web service. One embodiment of a system and method of the present invention is depicted schematically in FIG. 1.

For example, and with reference to FIG. 1, a smart contract for a lending transaction may be deployed into the Contract Blockchain by a developer of the smart contract, and later instantiated by a party, such as a borrower, seeking a loan on specific terms. Other parties, such as prospective lenders, may respond to the offer by accepting the terms or countering with other terms completely via an interface with the smart contract. If the borrower desires to accept the counter offer or further negotiate, those steps may be implemented as programmatic methods within the contract. The parties become bound upon digital signing of the instance of the contract on mutually agreeable terms. The terms may include parameters of the transaction such as the amount of money, the duration of the loan, the interest rate, the type of collateral, repayment terms, fees and penalty provisions, and other provisions that the parties may desire to incorporate into the transaction.

Additional parties may also become involved in the exemplary loan contract, such as a transfer agent who acts as an intermediary to ensure compliance with non-programmatic elements of the contract.

FIG. 1 depicts one embodiment of the method of using the blockchain loan transaction invention. In this method, the borrower initiates the transaction by requesting a loan. In other methods of using the system, the lender may have various loan offerings that are visible to users, who may apply for them. The process is very similar in that method to that shown in FIG. 1, with the lender initiating the process instead of the borrower.

Referring now to FIG. 1, an example of a Contract Blockchain and a method of using the Contract Blockchain with the system described herein is depicted. The Contract Blockchain 100 begins with a starting block A and consists of a linked lists of data blocks to the current termination of the blockchain at Block Z. As additional data is added to the blockchain from transactions submitted by users and processed by nodes on the distributed blockchain system, additional blocks of data are added onto the linked list of blocks that comprise the Contract Blockchain. The developer of the system described herein develops the Loan Contract smart contract as a computer-executable program code, and deploys it into block 102 of the blockchain 100 by submitting it as a transaction to the distributed blockchain system. When a block 102 is created that includes the Loan Contract, along with other transaction data, the block 102 is added as the terminating block of the blockchain. The Loan Contract may be written in a scripting language that is executed by interpreter software upon execution, or may compiled executable bytecode, object code data, or binary executable data.

The Loan Contract smart contract may be provided with one or more methods or functions that may be called by users of the smart contract to invoke certain functionality of the smart contract. Each method may constitute a separate function that may be executed by a user of the smart contract by providing any necessary parameters. The names of the methods provided in the Loan Contract smart contract are exemplary and are not limiting of the types and names of methods that may be provided in a Loan Contract. In the described embodiment of the invention the methods include a Loan Request method, a Loan Review method, a Loan Modify method, a Loan Accept method, among others. The smart contract may be accessed using its address on the Contract Blockchain, which may be published by the developer of the Loan Contract by distributing the address value provided to the developer when the Loan Contract is deployed.

At some later time after the Loan Contract is deployed to the Contract Blockchain a borrower initiates a request 104 for a loan by accessing the Loan Contract at block 102 and invoking the Loan Request method at step 106.

The Loan Request method may include some proposed loan terms, but need not include all potential terms. It may also include contact information for the borrower. The request is initiated by executing a Loan Request method defined as part of a smart Loan Contract on block 102 that exists on the Contract Blockchain. In some embodiments of the system, the Loan Request method may accept the proposed loan terms from the borrower and insert them into a later block in the blockchain 100, such as at block 108. Including such data into a later block in the Contract Blockchain may require the payment of a transaction or processing fee to the node that processes the data into a new block, the contract developer, or other appropriate third parties.

Since the Contract Blockchain is publicly available, at step 108 potential lenders may retrieve and review the Loan Request data placed on the blockchain 100 by borrowers who submit loan requests at step 110. In some embodiments some portions of the Loan Request data may be encrypted so that it is not publicly available, such as the identity and contact information of the borrower. The lenders may be able to directly access the Loan Request data stored in block 108 or they may utilize a method provided as part of the Loan Contract 102 to access the data. In some embodiments, the Loan Contract may provide methods to deliver block addresses for pending Loan Requests to a lender for direct access to the Loan Request Data, or the methods may accept a Loan Request identifier or blockchain address from the lender and return the Loan Request Data to the lender.

Once a lender reviews the Loan Request data, in some embodiments the Loan Contract 102 may provide a method 112 for the lender to submit a counteroffer or accept the Loan Request and agree to offer the loan. In various embodiments, the counter-offer terms may be sent directly to the borrower or may be incorporated into a later block 114 in the blockchain as part of a Loan Modify method of the Loan Contract. Similarly, once the parties agree on the terms the final terms of the specific loan contract may be incorporated into a later block in the Contract at step 114.

Once a loan agreement is finalized between the parties, then the actual loan transaction may be processed either totally or partially via programmatic means. In a typical loan transaction, the borrower will want to receive funds from the lender, and the lender will want to receive some kind of security such as collateral from the borrower. The exchange of funds for a security interest in collateral preferably takes place simultaneously, or through the use of a neutral intermediary that is trusted by both borrower and lender. If both funds and collateral can be transferred via programmatic means such as an electronic funds transfer of funds from the lender to the borrower, and a digital transfer of a virtual asset such as an on-line account or a virtual gaming asset from the borrower to the lender, then no neutral intermediary is needed and the smart contract can fully execute the closing of the Loan Contract, execute repayment, and release collateral upon full repayment.

In many instances, a neutral intermediary will be needed to facilitate the closing of the loan transaction and the release of collateral at the end of the loan repayment period, because the funds or the types of assets involved are not susceptible to completely programmatic transfer. The neutral intermediary will serve as a Transfer Agent to confirm that the parties transfer funds and assets as required by the loan agreement. The borrower and the lender may select a Transfer Agent during the loan negotiation process, or may select one after the loan agreement has been digitally executed by both parties. The Transfer Agent receives a fee for services, which may be paid by one of the parties, or split between them in an agreed upon manner.

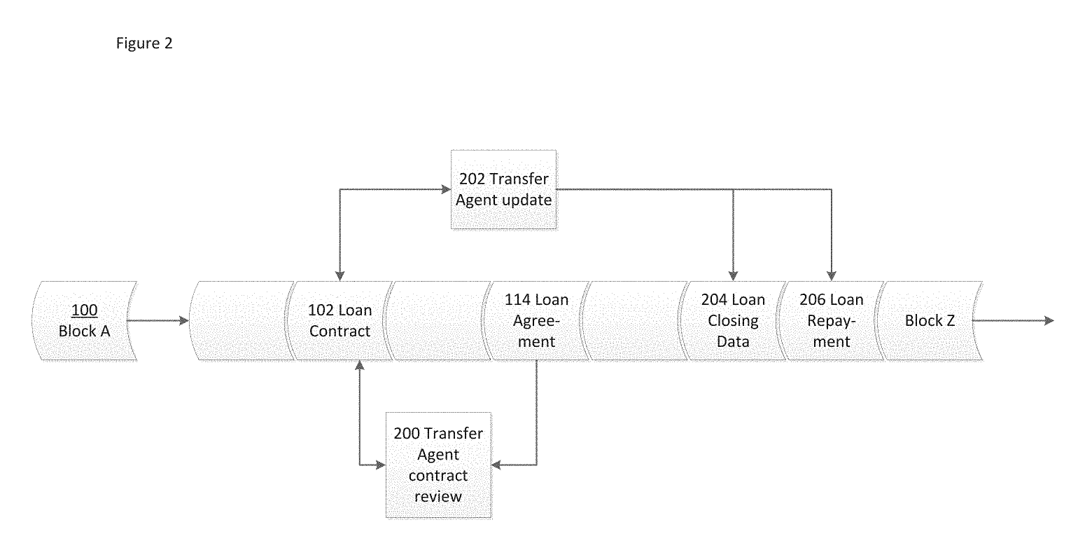

Referring now to FIG. 2, a schematic diagram of additional steps in embodiments of the inventive method are depicted. At step 200 the Transfer Agent utilizes the Loan Contract smart contract to review the information regarding a specific loan agreement for which the Transfer Agent will serve as the neutral intermediary. The Transfer Agent may then interact directly with the Borrower or the Lender or both to facilitate the closing of the loan transaction. For example, in some embodiments of the system and methods of this invention, the Transfer Agent receives signed documents from the Borrower granting a security interest in collateral to the Lender, or transferring title to an asset to a Lender. The Transfer Agent may be required to review the documents for correctness and completeness, and hold them until funds are received from the Lender. Similarly, the Transfer Agent may receive funds from the Lender and hold them until collateral is received from the Borrower, before disbursing the funds to the Borrower. Upon repayment of the loan, the Transfer Agent may also coordinate the return of collateral or the release of the security interest granted to the Lender.

Transfer Agent may query the Loan Agreement 114 using methods provided in the Loan Contract 102. Transfer Agent may submit data 204 to the blockchain documenting when each party complies with its obligations under the Loan Contract, and documenting the actual closing of the Loan using additional methods 202 provided by Loan Contract 102. Similarly, Transfer Agent may update data 206 into the Contract Blockchain to indicate various repayment events, including partial or total loan payments, and the completion of the release or return of collateral.

At various times during the transaction, the Transfer Agent may be required to file documentation as required to perfect security interests in the collateral, such as UCC financing statements, deeds of trust, lien notices, or other similar filings, and also to release such security interests as required by the loan agreement 114. The facilitation of the Transfer Agent to address processes that cannot be handled programmatically extends the scope of contractual arrangements that may be addressed using smart contracts.

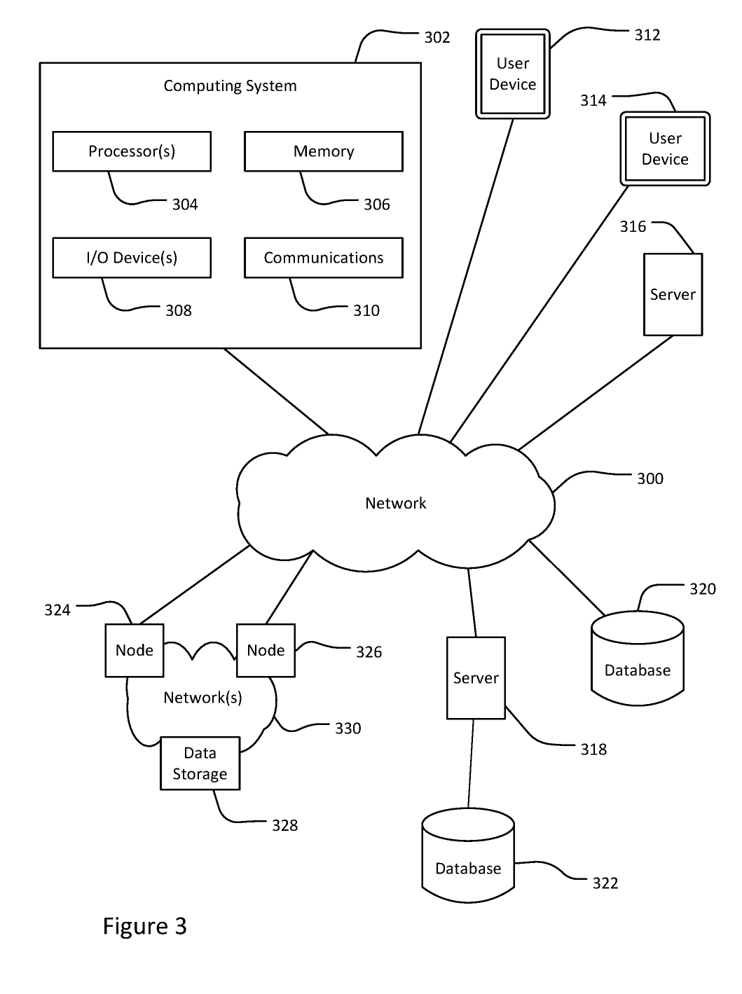

An exemplary computer or system hardware architecture in accordance with the embodiments of the WAX platform is shown in FIG. 3. A variety of devices operate in a networked environment indicated generally by network 300 which may use any of a variety of communication protocols as understood by one of ordinary skill in the art. Devices connected to network 300 may include, for example, computing system 302 which incorporates one or more processors 304, which may general purpose or special purpose processors. Computing system may also include one or more memory/storage devices 306, one or more input/output (I/O) devices 308 and one or more communications devices 310. Additional components may be included to provide the required embodiments of a computer system which can execute software and other computer-executable program code. Any of memory devices 306 may be a non-transitory computer readable storage medium.

Other devices may be connected to network 300, including user device 312, which may be a customer device such as a mobile phone, and user device 314 which may be a laptop, desktop computer or a handheld tablet, for example. Another component coupled to network 300 includes servers 316 and 318, which represent, for example, a data server, web server or a cloud computing device. Databases 320 and 322 may be coupled directly to network 300 as in the case of database 320, or coupled to a server as shown in the case of database 322.

Another type of computer system is shown where one or more nodes 324, 326 are connected to each other and to data storage 328 by network 330. Although two nodes are shown, any number of nodes may be included. Components 324, 326, 328 and 300 may, for example, operate as a peer-to-peer network for implementing a blockchain by confirming transactions.

Many different arrangements of the various components depicted in FIG. 3, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A method performed by a computing system, the method comprising:
deploying into a blockchain computer-executable program contract code of a loan contract specifying an asset to be transferred between a lender and a borrower, wherein said computer-executable program code further comprises one or more invokable methods;
under control of the contract code, deploying into the blockchain a loan request;
under control of the contract code, accessing the loan request and offering a loan; and
under control of the contract code, deploying into the blockchain a loan agreement specifying the terms of a loan between the lender and the borrower.

2. The method of claim 1, wherein the asset is digital and the loan transaction is executed under control of the contract code.

3. The method of claim 1, wherein the asset is tangible, further comprising:
selecting a transfer agent;
executing the loan agreement; and
deploying into the blockchain loan repayment data.

4. The method of claim 1 wherein the one or more invokable methods further comprise a loan request method, a loan review method, a loan modify method and a loan accept method.

5. The method of claim 4, wherein a loan request method further comprises:
accepting at least one proposed loan term from the borrower; and
deploying into the blockchain the at least one proposed loan term as a loan request.

6. The method of claim 4 wherein a loan review method further comprises:
reviewing a loan request; and
deploying into the blockchain an acceptance of the loan request.

7. The method of claim 4, wherein the loan modify method further comprises:
under control of the contract code, deploying into the blockchain a counter offer.

8. The method of claim 4, wherein the loan accept method further comprises:
deploying into the blockchain an agreement on the final terms of the loan contract.

9. A computing system for executing a loan transaction, the computing system comprising:
a processor for executing computer-executable instructions; and
a computer-readable storage medium containing computer-executable instructions that when executed by the processor control the computing system to:
deploy into a blockchain computer-executable program contract code of a loan contract specifying an asset to be transferred between a lender and a borrower;
deploy into the blockchain a loan request; and
deploy into the blockchain a loan agreement specifying the terms of a loan.

10. The computing system of claim 9, wherein the asset is digital and the loan transaction is executed under control of the contract code.

11. The computing system of claim 9 wherein the asset is tangible and the computer-readable storage medium containing computer-executable instructions that when executed by the processor control the computing system to:
select a transfer agent;
execute the loan agreement; and
deploy into the blockchain loan repayment data.

12. The computing system of claim 9 wherein the one or more invokable methods further comprise a loan request method, a loan review method, a loan modify method and a loan accept method.

13. A method performed by a computing system for executing a loan transaction, comprising:
deploying into a public blockchain computer-executable program contract code of a loan contract specifying an asset to be transferred between a lender and a borrower, wherein said computer-executable program code further comprises one or more invokable methods;
under control of the contract code, providing access to an invokable loan request method for requesting a loan to a borrower;
under control of the loan request method, deploying into the public blockchain a loan request further comprising at least one term of the loan;
under control of the contract code, providing access to an invokable loan review method for accessing the loan request to one or more lenders; and
under control of the contract code, providing access to an invokable loan accept method for accepting the loan request to one or more lenders and deploying a loan agreement to the public blockchain.

14. The method of claim 13, wherein the loan request further comprises contact information for the borrower and a lender contacts the borrower directly.

15. The method of claim 13 wherein the asset is digital and the loan transaction is executed under control of the contract code.

16. The method of claim 13 wherein the asset is tangible, further comprising:
selecting a transfer agent to execute the loan agreement and deploy into the public blockchain loan repayment data.

17. The method of claim 13, wherein the loan agreement further comprises collateral for the loan.

18. The method of claim 17, wherein the collateral further comprises a virtual gaming asset.

19. The method of claim 13 wherein the one or more invokable methods further comprise a loan modify method.

20. The method of claim 19, wherein the loan modify method further comprises under control of the contract code, deploying into the blockchain a counter offer.
